(19) United States
(12) Patent Application Publication
(10) Pub. No.: US 2011/0273877 A1
(43) Pub. Date: Nov. 10, 2011

(54) Linear Lighting System

(75) Inventors: Mark C. Reed, West Chester, OH (US); John Delmore Boyer, Lebanon, OH (US)

(73) Assignee: LSI Industries, Inc., Cincinnati, OH (US)

(21) Appl. No.: 13/101,649

(22) Filed: May 5, 2011

Related U.S. Application Data
(62) Division of application No. 12/064,844, filed on Oct. 6, 2008.

(51) Int. Cl. F21V 7/00; F21S 4/00

(52) U.S. Cl. 362/235; 362/249.02

(57) ABSTRACT

A luminaire for lighting a traffic surface in a tunnel is disclosed, wherein the luminaire has light sources disposed in an array for casting light on a traffic surface and structure for controlling and directing the light, such as a reflector or refractor lens. The luminaires are positioned along the length of the tunnel at angles to the traffic surface facilitating optimal use of the generated light. The luminaire is configured as a module that can be quickly installed into a support track mounted on the tunnel walls, and is dust and waterproof to endure mechanical and high pressure water cleaning by conventional tunnel washers. The luminaire is particularly well suited to employ light emitting diodes for generating and casting light.

### FIELD OF THE DISCLOSURE

The present disclosure relates to a lighting apparatus and, more specifically, to a lighting apparatus for illuminating traffic tunnels. Embodiments of the present disclosure can be particularly useful for distributing light emitted from one or more light emitting diodes (LEDs), as described herein, but may be used with any type of light source.

### BACKGROUND OF THE DISCLOSURE

LEDs have improved in terms of quality, performance and cost, and their use and popularity have been growing. LED lighting provides, and has the further potential, to reduce the power consumption per unit lumen. This application is a divisional application of U.S. patent application Ser. No. 12/064,844 filed Oct. 6, 2008, which is a 371 nationalization of PCT/US2006/034,718 filed Sep. 6, 2006, which claims priority to U.S. Provisional Patent Application No. 60/714,428 filed Sep. 6, 2005.

Tunnel and bridge lighting have used incandescent, fluorescent and more recently high intensity discharge (HID) lamps that can provide adequate amounts of lighting, but which have several drawbacks, including frequent (at least annually) lamp failures and uneven lighting of the traffic surface and tunnel walls. Tunnels for highways and roadway can have earthen or rock walls and ceilings, or constructed walls or ceilings made or lined with concrete, ceramic tile, or other construction material. Tunnels also come in a wide variety of shapes and sizes. Some tunnels have a domed ceiling and wall shape, while others have vertical walls and substantially horizontal ceilings. Some tunnels are short, allowing one to easily see the exit to the tunnel even as one enters the entrance. Many tunnels are long enough that one can not see the exit port of the tunnel as one enters the entrance port and travels along the tunnel. Some tunnels are straight, while others have a curved roadway in the horizontal plane, while others may have a ascending or descending roadway.

In addition, driving through a tunnel at night requires different lighting than driving in the daytime. The variability in the types of tunnels and driving conditions makes it a challenge to develop a lighting system that can be installed and easily adapted to any tunnel.

### SUMMARY OF THE DISCLOSURE

The present disclosure provides a linear lighting system for lighting a traffic surface, comprising: a linear luminaire comprising a plurality of light sources disposed in a linear array along the length of the traffic surface, and a plurality of light-controlling means for directing the emitted light from the light sources at the traffic surface.

The linear lighting system is useful in the directional lighting of automotive traffic tunnels and bridges, train and subway stations and tunnels, and pedestrian hallways, walkways, corridors, canals and tunnels, and other traffic surfaces. In particular, the present invention provides a linear lighting system for lighting a traffic tunnel and its traffic surface, comprising: a linear luminaire comprising a plurality of LEDs or other light sources disposed in a linear array along the length of the traffic tunnel, and a plurality of light-controlling structures for directing the emitted light from the light sources at the traffic surface and/or the walls and ceiling of the traffic tunnel.

When the light source is a LED, the light-controlling structure for directing the emitted light from the light sources is selected from the group consisting of a refractor lens, a reflector, and a combination thereof. The light-controlling structure is configured to associate with the light sources to direct the emitted light predominantly toward the traffic surface, and/or toward the tunnel surfaces.

Embodiments of the present disclosure can also relate to a linear luminaire comprising:

1) a linear array light fixture;

2) an elongated light-transmitting window having opposed first and second longitudinal sides; and

3) an elongated housing having a base portion that encloses the frame, and a pair of arms extending from the base, the distal end of each arm receiving one of the opposed longitudinal sides of the elongated window, wherein the distal ends of the arms can be biased away from one another for insertion of the longitudinal sides of the elongated window. The linear array light fixture can utilize light sources such as LEDs and fluorescent tubes. A typical linear array light fixture comprises: a. an elongated light board comprising a plurality of LEDs arranged in a substantially linear array along the length of the board, and b. an elongated frame for supporting the elongated light board.

The elongated light-transmitting window is typically transparent. and typically made of a glass or a resilient plastic such as polycarbonate.

The receiving portion of each distal end of the arm may comprise a pocket or other structure that captures and secures the longitudinal side edge of the light-transmitting window.

The elongated frame is an elongated member that corresponds substantially in length with and engages and holds the elongated light board at a plurality of positions or entirely along the length, or can comprise a plurality of frame elements that can be configured to engage and support the elongated light board at its ends or along its length.

The housing typically is unitary and made from a resilient material that allows the ends of the arms to be biased outwardly but returns to a fixed position when unbiased by an external force. Typically materials for constructing the housing can be selected from the group consisting of metals, including stainless steel and aluminum, and plastics, such as acrylic and polyacrylic (Plexi-glass™), polyvinyl chloride (PVC), polycarbonate, and polystyrene.

The housing also may have a gasket to create a moisture seal between the longitudinal side of the light-transmitting window and the pocket or receiving portion of the arm of the housing. The housing also comprises structure for enclosing, preferably sealing off, the opposed longitudinal ends of the elongated housing. The light sources can have an associated light-controlling reflector having a proximal opening disposed around the base of the light sources, and a distal opening defined by a distal rim disposed adjacent to the inner surface of the elongated window to create a light barrier that prevents light from escaping between the rim and the inner surface of the window.

An embodiment of the present disclosure further relates to a method for lighting an automotive tunnel, comprising:
a. providing an automotive tunnel having a traffic surface having a first side and a second side, and a plurality of tunnel walls including a first tunnel wall adjacent the first side of the traffic surface, and a second tunnel wall adjacent the second side of the traffic surface.
b. positioning a plurality of linear luminaires comprising a plurality of LEDs arranged in a substantially linear array horizontally along at least one of the tunnel walls, and
c. directing and controlling the emitted light from the LEDs wherein at least 50% of the emitted light from the LEDs is directed at the traffic surface.

The LED lights are spaced apart by a horizontal distance of not more than 0.5 meter, and typically not less than 0.5 cm.

The present invention also relates to a method for lighting an automotive tunnel having high reflective tunnel walls, comprising the steps of:
a. providing an automotive tunnel having a traffic surface having a first side and a second side, and a plurality of tunnel walls comprising a first tunnel wall adjacent the first side and a second tunnel wall adjacent the second side of the traffic surface, wherein at least the second tunnel wall has an exterior surface having a reflectance of at least 30%.
b. positioning a plurality of linear luminaries comprising a plurality of LEDs arranged in a linear array, horizontally along at least the first tunnel wall; and
c. directing and controlling the emitted light from the plurality of LEDs whereby at least 50% of the emitted light is directed at the exterior surface of the second wall and reflects from the second wall to the traffic surface adjacent the second wall.

Typically, the external surface of the walls are made using a material that has high reflectance, such as ceramic tile, concrete, as well as painted concrete and other painted surfaces. The reflective external surface typically has a reflectance of at least 30%, and more typically of at least 40%, and up to about 70%, and more typically up to about 60%, wherein emitted light from the plurality of LEDs is reflected by the reflective surface of the second wall to the traffic surface.

Typically LEDs are positioned along both the first and second tunnel walls, both having reflective surfaces.

An embodiment of the present disclosure also relates to a linear lighting system and a method for installing linear luminaires into a traffic tunnel, by employing a luminaire support system comprising: a plurality of power and control interface modules affixed to a tunnel wall at existing power nodes along the length of the tunnel wall; a plurality of luminaire support track sections affixed at a first end to a first power and control interface module, and at a second end to a second, adjacent power and control interface module; a plurality of linear luminaries, as described herein, affixed to the luminaire support tracks; and a means or structure for providing power from each power and control interface module to the linear luminaires. The luminaire support track sections can consist of two or more separate luminaire support tracks which are joined together. Each luminaire support track may be associated with one or more linear luminaire. In a typical embodiment, the luminaire support track is constructed to avoid attachment to or support from the tunnel wall at positions between adjacent power and control interface modules.

Aspects of the disclosure may be more fully understood from the following description when read together with the accompanying drawings, which are to be regarded as illustrative in nature, and not as limiting. The drawings are not necessarily to scale, emphasis instead placed on the principles of the disclosure. In the drawings:

### BRIEF DESCRIPTION OF THE DRAWINGS

FIG. 1 shows an exploded view of a first embodiment of a linear luminaire of the present disclosure.

FIG. 2 shows a cross sectional view of the linear luminaire of FIG. 1 through line 2-2.

FIG. 3 shows a cross sectional view of a first tunnel with a roadway that is illuminated by a linear luminaire system of the present disclosure.

FIG. 4 shows a cross sectional view of an alternative embodiment of the linear luminaire.

FIG. 5 shows a module of a linear array light fixture used in the linear luminaire.

FIG. 6 shows a cross sectional view of a second tunnel with a roadway that is illuminated by a linear luminaire system of the present disclosure.

FIG. 7 shows a perspective of a luminaire support or track system used for installing the linear luminaire system into a roadway tunnel.

FIG. 8 shows a cross sectional view of the track system affixed to a tunnel wall, taken through line 8-8 of FIG. 7.

FIG. 9 shows a cross sectional view of the track system with a linear luminaire secured therein, taken through line 9-9 of FIG. 7.

FIG. 10 shows another cross sectional view of the track system with a linear luminaire secured therein, taken through line 10-10 of FIG. 7.

While certain embodiments depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

### Linear Luminaire

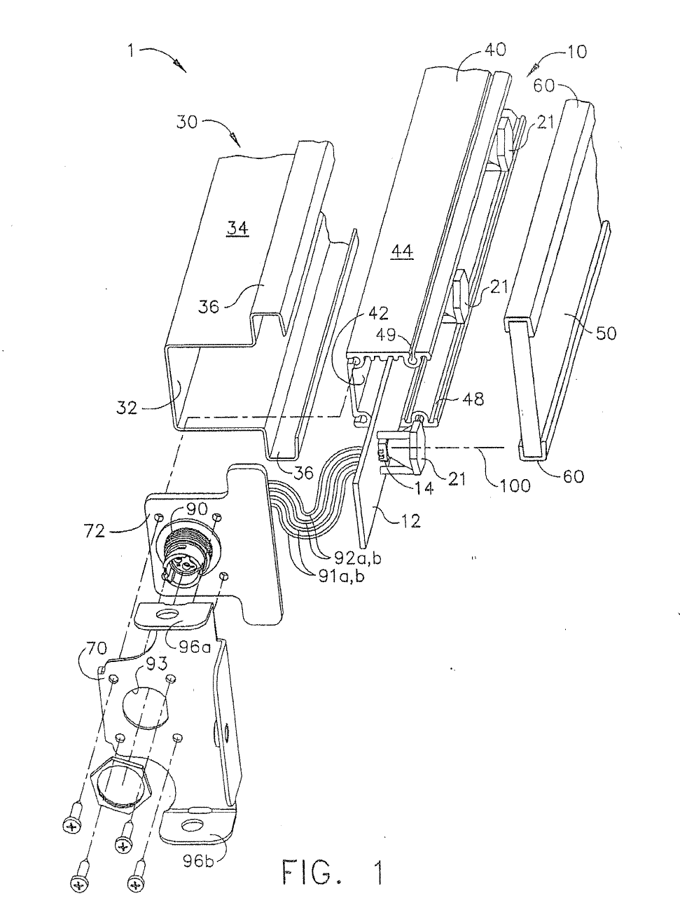

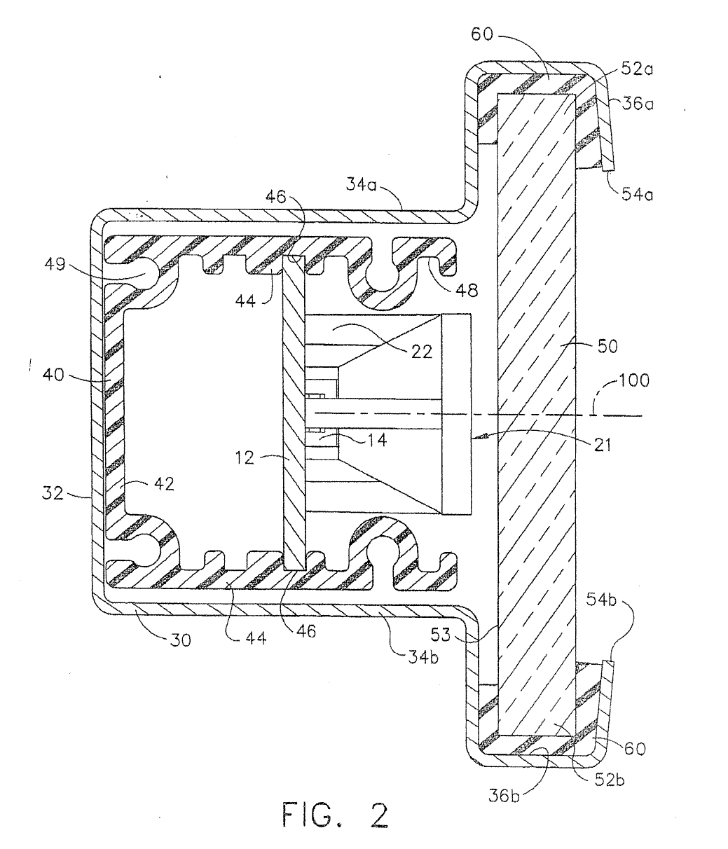

FIG. 1 shows an exploded view of a linear luminaire 1 consisting of a linear array light fixture 10, a housing 30, and a light-transmitting window 50. FIG. 2 shows a sectional view of the linear luminaire.

As shown in FIGS. 1 and 2, exemplary embodiments of a linear luminaire 1 can include a linear array light fixture 10 having an elongated light board 12 and a plurality of discrete light sources 14. Although the embodiments shown and described herein are shown and described as utilizing one or more LEDs as light sources, other light sources are also contemplated and may be substituted for the disclosed LED(s). In the embodiment depicted in FIGS. 1 and 2, LEDs are arranged in a substantially linear array along the length of the elongated light board 12. The array is shown as a single line of LEDs, centered at a longitudinal distance of at least 0.5 cm, and up to about 50 cm, though more typically at least 2 cm, and up to about 20 cm.

The linear array of LEDs can include a series of LEDs wherein some of the LEDs are staggered, for example where alternating LEDs are raised slightly above or dropped below a main line of LEDs.

The elongated light board 12 is typically a metallic clad resin board, typically aluminum clad, to help dissipate the heat of the LEDs. The LEDs 14 are powered by an AC or DC power source (not shown) that provides at least about 0.25 W per LED. The power source can also be associated with a means for electronic control of the current flow. Power sources and controllers are available from LSI Saco Technologies Inc. of Cincinnati, Ohio, and others. The luminous intensity and luminance from LEDs closely approximates a linear response function with respect to applied electrical current over a broad range of conditions. In addition, recent generations of AlInGaP, AlGaAs, and GaN LEDs draw less electrical power per lumen or candela of visible light produced than incandescent lamps, resulting in more cost-effective, compact, and lightweight luminaires.

A discrete LED component 14 is a conventionally available LED, and can include such LED devices such as T 1, T 1-¾, T 5, surface mount (SMD), axial-leaded “polyleds,” and high power packages such as the SuperNova, Pirahna, or Brewster lamps, all of which are available with a variety of options known to those skilled in the art such as color, size, and beam width, and can be obtained from manufacturers such as Hewlett Packard, Inc., Optoelectronics Division, located in San Jose, Calif. Osram Sylvania, Ltd. located in Danvers, Mass., Stanley Electric Company, Ltd. located in Tokyo, Japan, Philips-Lumiled located in Somerset, N.J., Nichia Chemical Industries. Ltd. located in Anan-shi. Tokushima-ken. Japan and many others. Discrete LEDs are the dominant form of LEDs in general use because of their generic shapes and ease of processing in standard printed circuit board assembly operations. A typical LED useful in the present invention is Philips' Luxeon® III Emitter LED.

The elongated light board 12 provides support for, delivers electrical power to, and maintains a spatial relationship between, the plurality of discrete LEDs 14. The structure of the elongated light board 12 will vary depending on the specific design of the LEDs 14 and of the linear luminaire 1. In a preferred embodiment, the light board 12 is a printed circuit board. A discrete LED 14 generally consists of a pre-assembled or packaged “lamp” which normally includes a metal lead frame or other substrate for electrical and mechanical connection and internal mechanical support, a semiconductor LED chip or “die”, a conductive adhesive or “die attach” for electrically and mechanically attaching one electrode of the chip to the lead frame or other substrate, a fine wire conductor for electrically connecting the other electrode of the chip to an area of the lead frame or other substrate which is electrically isolated from the first electrode and die attach by the chip itself. Finally, a clear, tinted, or slightly diffused polymer matrix enclosure is used to suspend, encapsulate, and protect the chip, lead frame, optional reflector cup and wire conductor, and to optionally provide certain desirable optical characteristics.

In a conventional LED 14, the polymer matrix enclosure typically comprises an optically clear epoxy or any number of materials capable of protecting the LED chip from environmental contaminants such as moisture. The upper portion of lead frame is connected to the LED semiconductor chip and a lower portion of lead frame extends out one end of the enclosure to attach to the printed circuit board 12 and provide electrical connection to an electronic control circuit through wires (not shown). The control circuit is operable to energize, control, and protect the LEDs 14, and manipulate and manage the illumination they produce. Many variations of electronic control circuit will be known to those skilled in the art and will vary depending on the application for linear luminaire 1.

A second configuration of LEDs can be a plurality of LED chips mounted in an intermediate manufacturing step directly onto a printed circuit board, ceramic substrate, or other structure to support the individual LED chip and provide electrical connections to it. When a plurality of LEDs is so mounted, the result is a “chip-on-board” LED array that in its entirety can then be incorporated into other assemblies as a subcomponent. Individual LED chips suitable for the present invention are available from Hewlett Packard, Showa Denko, Stanley, and Cree Research.

In most conventional discrete LED designs, the polymer matrix enclosure also functions as an integral optical element, such as a lens, deviator, or diffuser for the emitted light. The LEDs have the refractor element (e.g., refractor lens 21) molded into the LED. A separate or secondary optical refractor lens 21 can also be incorporated with the LED 14 to improve illuminator performance or appearance. The optical refractor lens 21 is positioned by support legs 22 attached to or supported by the printed circuit board 12 in position over the LED. The refractor lens 21 is normally a magnifier/collimator that serves to collect and project the light emitted by each conventional LED 14, into a narrower and more intense beam of directed light than otherwise would occur. The refractor lens 21 is commonly made separate from the polymer matrix enclosure, but can be made integrally. Lens 21 can also be made as an integral array of lenses that are then substantially registered about the centers of individual conventional discrete LEDs. In a preferred embodiment, the refractor lens 21 conform the emitted light into a conical pattern, such that the angle of the light having 50% light emittance, relative to the light emitted along the centerline through the LED, lays at an angle of about 12° from the centerline 100 through the LED, though more generally in the range of about 5° to about 35°.

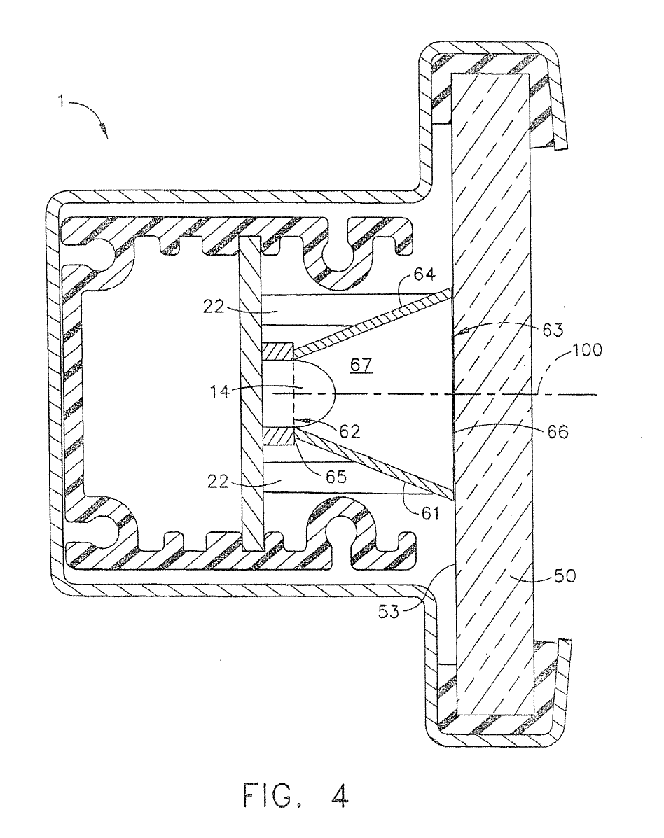

A reflector 61, as shown in FIG. 4, can be used with the above-described conventional discrete LED or LED chip-on-board design. The reflector 61 may be a conical, parabolic, or elliptical reflector and can be made of metal or metal-coated molded plastic. The purpose of the reflector is to collect or assist in the collection of light emitted by the LED chip, particularly the light emitted at high angles (up to 90°) from the centerline or axis of the diode. The reflector projects this light forward in a narrower and more intense beam. Suitable reflectors are well known to those skilled in the art and can be obtained from a wide variety of optical molding and coating companies such Reed Precision Microstructures of Santa Rosa, Calif.

In exemplary embodiments, the reflector 61 is positioned adjacent each LED 14 to surround the base of the diode. The reflector element 61 can have a frusto-conical shape, although other common cross-sectional shapes are elliptical and parabolic. The reflector 61 has a proximal opening 62 defined by proximal rim 65 disposed around the base of the LED bulb, and a distal opening 63 defined by distal rim 66 of the conical reflector wall 64. The inner surface 67 of the wall 64 can be highly reflective, to efficiently and effectively direct the emitted light of the LED that has an emission angle of about 90° to about 60° from the LED centerline 100. The light can reflect off of the inner reflective surface 67 at an angle substantially parallel to centerline 100. The conical cross sectional shape of the reflector element 61 as shown in FIG. 4 has substantially straight sidewalls, although other embodiments can have parabolic, elliptical or other curved or linear surfaces.

In exemplary embodiments, the distal rim 66 of the reflector element 61 is disposed adjacent to, and more typically, flush with the inner surface 53 of the elongated light transmitting window 50. The distal rim 66 of the reflector element 61 can be disposed directly against the inner surface 53 of the window 50 to create a light barrier that prevents LED light from escaping between the distal rim 66 and the inner surface 53 of the light-transmitting window 50. An optional optical sealing member or gasket can be disposed between the circumferential distal rim 66 of the reflector element 61 to improve the light barrier and the fit of the reflector element 61 against the window 50 during assembly.

As shown in FIGS. 1 and 2, an elongated support frame 40, shown as a U-shaped channel, has a base 42 and a pair of sides 44 extending from the ends of the base 42. The extending sides 44 have a first pair of inwardly-facing grooves 46. The support frame 40 can be a light-weight metal such as aluminum, or a plastic, and may be formed by extrusion. The support frame also includes a plurality of securement means or fastening structures, shown as openings 49, through which a screw 99 or other fastener can be run for positioning and securing the support frame. The frame 40 includes an optional outermost pair of lens grooves 48 between which an optional dedicated protective lens, or an optional refractive lens can be secured.

The printed circuit board 12 is shown partly withdrawn from the support frame 40, between the pair of inwardly-facing grooves 46. The support frame 40 may be of the same length as the printed circuit board 12 so that the longitudinal ends of the printed circuit board are flush with the ends of the support frame. The power and controls can be affixed to the back of the printed circuit board, or can be affixed to a second board disposed within another opposed pair of inner channels of the support frame 40. In exemplary embodiments, the power source and controller can be disposed remote from the assembly linear array light fixture, and connected to the light fixture by an electronic circuit that includes a separate circuit for electrical power and for electronic controls.

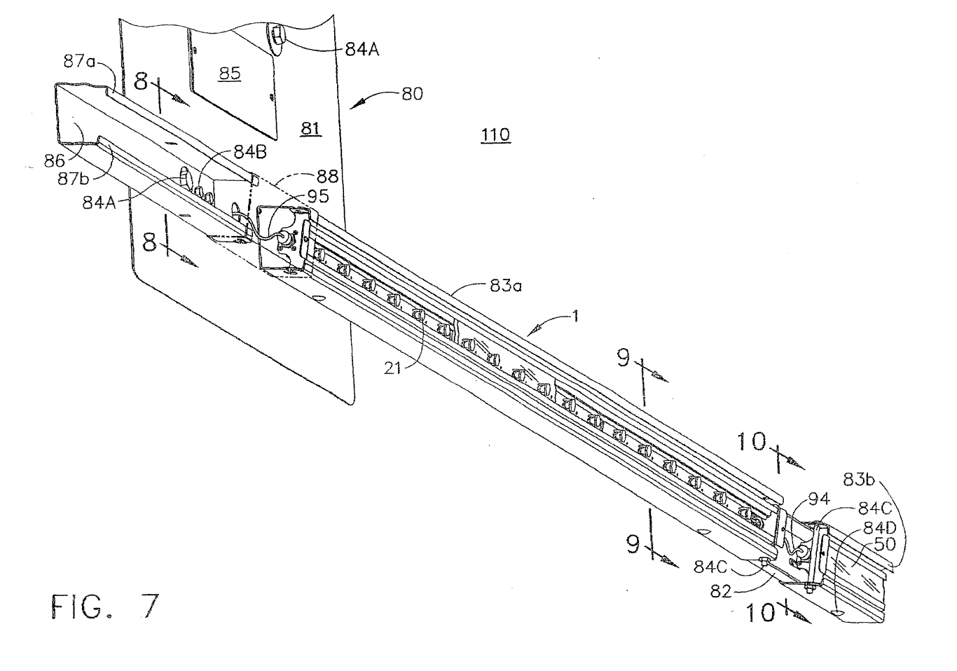

As shown in FIG. 1, an electric connector 90 is associated with each end of the printed circuit board 12 via at least one pair of control wires 91 a,b and at least one pair of power wires 92a,b. The electrical connector 90 is shown associated with the gasket member 72 for positioning the connector 90 proximate the ends of the linear array light fixture 10. A clearance hole 93 is formed through each end plate 70 to allow the electrical connector 90 to extend there through, thereby providing each linear luminaire 1 with both power and control connections on each end. A suitable bridging cable 94 can be connected between electric connectors 90 at the confronting ends of adjacent linear luminaries 1 to provide power and/or control to the linear luminaries 1 in the linear lighting system (as shown in FIG. 7).

The LED, refractive lens, and the printed circuit board are available individually or as a unit from LSI Saco Technologies Inc., Phillips Electronics, and Cree Inc. of Durham, N.C.

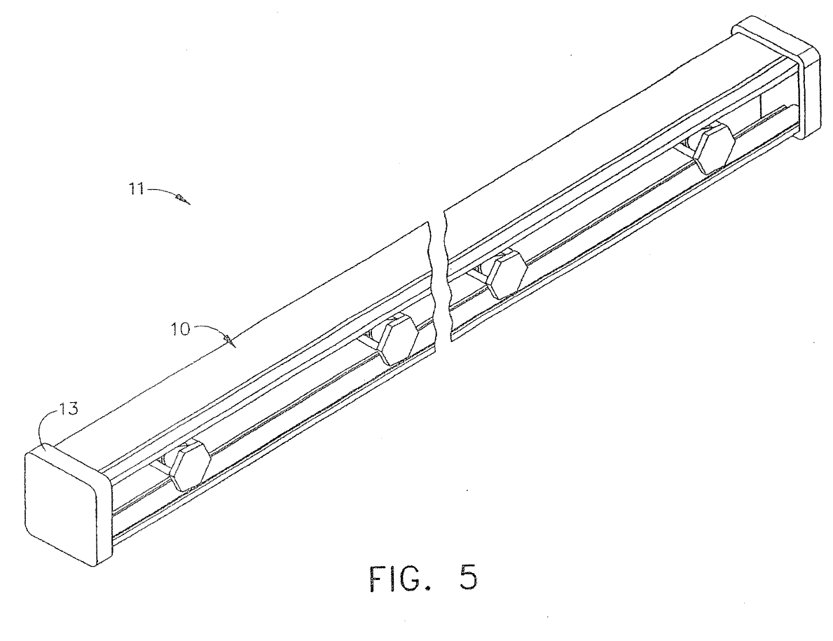

As shown in FIG. 5, the support frame 40 and printed circuit board 12 with LEDs 14 that comprise the linear array light fixture 10 can be assembled into a cartridge 11 and capped with removable caps 13 over the ends of the support frame 40, to provide a replacement cartridge in the event that one, more or all of the LEDs 14 on a printed circuit board extinguish or diminish in performance.

The elongated housing 30 for the linear luminaire 1 typically encloses the linear array light fixture 10. The distal ends of the elongated arms 34 have a c-shaped pocket 36. The pockets 36 are configured to secure the longitudinal edges 52a and 52b of the window 50. The arms 34 extending from base 32 are configured to flex outward, away from one another, to allow the width of the window 50 to be slipped between the distal edges 54a and 54b of the opposed pockets 36a and 36b. In one embodiment, the housing can be made of stainless steel, aluminum, or a plastic such as polycarbonate, nylon, Plexiglass™, polyvinyl chloride (PVC), polystyrene and polyacrylic. A gasket material 60 is typically wrapped around and secured to both edges of the window 50 to create a waterproof seal along both the front face and rear face 53 of the window edges 52a and 52b, with the respective pockets 36a and 36b. The gasket material can be silicone, rubber, and other materials well known for use as a sealing gasket.

The housing 30 can include a means or structure for enclosing, preferably sealing, the opposed longitudinal ends of the linear array light fixture 10. The illustrated embodiment shows an end plate 70 that secures an end gasket 72 to each end of the housing 30, secured by a plurality of screws 99 that thread into the openings 49 of the support frame 40, to assembly the linear luminaire 1. The end plate can includes means or structure 96a,b for positioning and securing the assembled linear luminaire 1 to a light mounting bracket or track on the wall or ceiling of a tunnel, bridge or hallway, as shown in FIGS. 7-10.

The light transmitting window 50 can be made from a transparent glass or plastic material, to allow optimum transmission of the emitted light from the luminaire. Materials can include glass, such as quartz and silica, and plastic, such as Plexi-glass™, polycarbonate, polystyrene and polyacrylic. The window can be a rectangular shape in plan view. The window is typically planar, to pass maximally the light there through without any refracting of the passing light optically it can have a outwardly-facing concave shape to concentrate and/or direct or focus the light passing out the linear luminaire.

### Lighting of a Traffic Tunnel

The lighting of tunnels for vehicle traffic has certain requirements, primarily related to safety. One requirement of the lighting system is to light the entrance and exits of the tunnel sufficiently to provide transition from the external luminance created by weather conditions and/or the position of the sun. Another important requirement for lighting is known as the flicker effect. In the interior of a lighted tunnel where luminaires or their reflected images are in full or partial view of the vehicle occupants, the stroboscope effect of passing closely spaced light sources may produce undesirable behavioral sensations and annoyance.

The linear lighting system of the present invention spaces the light sources at distances sufficiently close so that the stroboscopic effect is nominalized or avoided. The linear lighting system also is configured to direct the emitted light from the LEDs into a direction perpendicular from the surface of the tunnel wall and to the axis of the tunnel, to limit direct glare (that is, light emitted directly from an unshielded lamp) to operators and passengers of vehicles traveling through the tunnel. Light emitted “perpendicular” to a tunnel wall or a traffic surface can include light that is angled slightly, up to 10°, from true perpendicular.

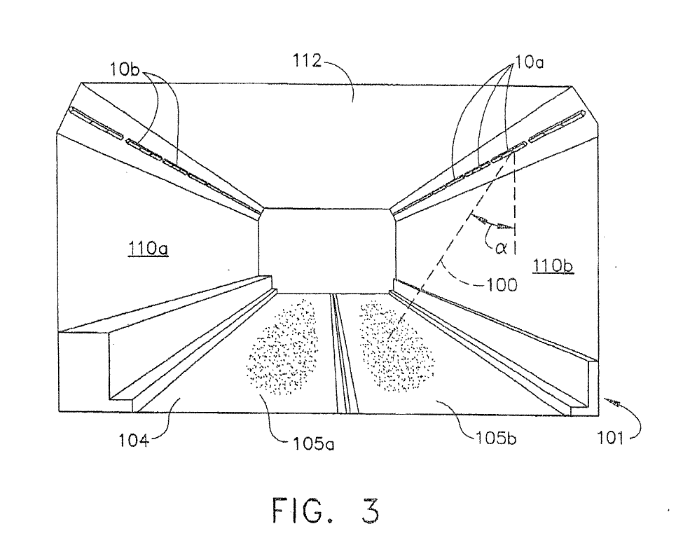

FIG. 3 shows the use of LEDs light sources in a lighting system for illuminating a traffic surface in a tunnel 101. The traffic surface 104 can be a roadway, floor, rail tracks or other pathway for people, cars, truck, boats, trains, and other vehicles. Typical traffic surfaces include those passing through tunnels and hallways, and across bridges. The illustrated traffic surface is a traffic tunnel having a first traffic lane 105 a and a second traffic lane 105b, for automotive or truck traffic flowing in either the same or opposite directions.

The LEDs disposed in the light array light fixtures are arranged in a linear array along the length of the traffic surface 104. The rows of light luminaires bearing LEDs are arranged in series and preferably continuously. The rows of linear luminaries can be spaced end-to-end, or can have a minimum spacing sufficient to maintain adequate lighting and minimizing any stroboscopic effect. The LEDs that are spaced closely may give the appearance to a person passing along the length of the roadway that the light source is substantially continuous and linear.

Since nearly all existing tunnels and other roadway and other traffic surfaces are being lit by conventional light sources, it will be common for linear LED luminaries to be retrofitted into such facilities. This typically requires use of existing power and control circuits for the replacement of fluorescent, incandescent and HID lamp fixtures.

Exemplary embodiments of the present disclosure can relate to a linear lighting system and a method for installing linear luminaires into a traffic tunnel. The linear lighting system employs a luminaire support system that comprises: a plurality of power and control interface modules affixed to a tunnel wall at existing power nodes along the length of the tunnel wall; a plurality of luminaire support track sections affixed at a first end to a first power and control interface module, and at a second end to a second, adjacent power and control interface module; a plurality of linear luminaries, as described herein, affixed to the luminaire support tracks; and a means for providing power from each power and control interface module to the linear luminaires.

hi conventional tunnel lighting, power and control circuits are embedded into the side walls and/or ceilings of the tunnel. Lighting fixtures, such as HID, incandescent and fluorescent lamp fixtures are positioned along the length of the tunnel, along one wall or both walls or ceiling. Typically, a portion of the wall material is removed to accommodate the mounting of the power and control wiring and conventional light fixture. When the original or existing light system is removed, these fixture openings in the walls of the tunnel are available for installing of the new LED linear lighting system.

Along the length of the tunnel, power and control interface modules are installed. The power and control interface module typically consists of means for connecting any existing power or control circuits to the new linear lighting system, and a means to cover or secure the existing fixture opening, such as a cover plate. The cover plate covers the fixture opening, and mounts flush with the side wall of the tunnel, such as with bolts or similar hardware. Existing power and control circuits are threaded through liquid-tight ports in the cover plate, for connection with the linear luminaires of the linear lighting system.

The power and control interface modules also provide a means for attaching thereto luminaire supports that span the distance between two adjacent power and control interface modules. Depending on the distance between adjacent modules, the luminaire supports do not require direct connection to and support from the tunnel walls. The luminaire support can be a single element, or a plurality of connectable elements. The luminaire supports in turn are configured to support and secure the LED linear luminaire, and optionally any associated power and control circuits. The luminaire supports can be configured to hold the linear luminaire in a single position to direct the LED light away form the tunnel wall at a pre-determined angle, or can comprise further a means for adjusting the position of the linear luminaire to adjust the angle of direction of the LED light from the tunnel wall. The adjustment permits a single luminaire support system to be installed into any type of tunnel, or to simply fine-tune the lighting needs of any tunnel lit therewith.

The lighting system of exemplary embodiments of the present disclosure also allows for the replacement of the white (5500 K) LED lamps with different colored lamps (LEDs that emit a different visible color), or multi-color lamps (a single lamps that can emit a variety of different colors), to obtain particular lighting effects or advantages. For example, an LED or a group of LEDs can be used to identify exit lanes, locations of emergency phones, and fire and safety equipment, and to indicate other warnings or alerts, such as lane direction changes.

In exemplary embodiments, the plurality of linear luminaries 1 can be position along wall 110 or the ceiling 112, or both, of at least one side of the tunnel. The linear luminaries 1 can be positioned edge to edge, or with short spacing, to provide a substantially linear array of LED lights along the length of the tunnel. In the illustrated embodiment, the LED linear luminaire 1 is positioned near the top on each opposite tunnel wall 110a and 110b. In the embodiment shown in FIG. 3, the emitted light by the linear array light fixture 10a is directed at substantially the center of the adjacent traffic lane 105a or 105b. The centerline 100 of the array of LEDs, and light beams emitted in a cone shape centered around the centerline, is disposed at an angle of about 20° from vertical onto the roadway surface 104, though typically at an angle of from about 15° to about 45°. At a distance of about 15 feet (4.6 meters), the main illumination pattern is a circle of about 6.4 feet (1.9 meters). By spacing the matrix of LEDs within the linear luminaire 10 on 4-inch (10 cm) centers, the plurality of overlapping illumination patterns provides uniform light illumination along the length of the roadway through the tunnel 102 and across substantially the entire width of the respective traffic lanes 105a and 105b. The light emitted outside of the 50% emittance cone provides an adequate amount of lighting for the tunnel walls and areas beyond the traffic lanes.

In another embodiment, not specifically shown, the linear luminaries 1 can be affixed to the tunnel wall 110b in a linear array, and positioned to direct the emitted light along the centerline 100 of the LEDs at the far or opposite traffic lane 105a, and visa versa.

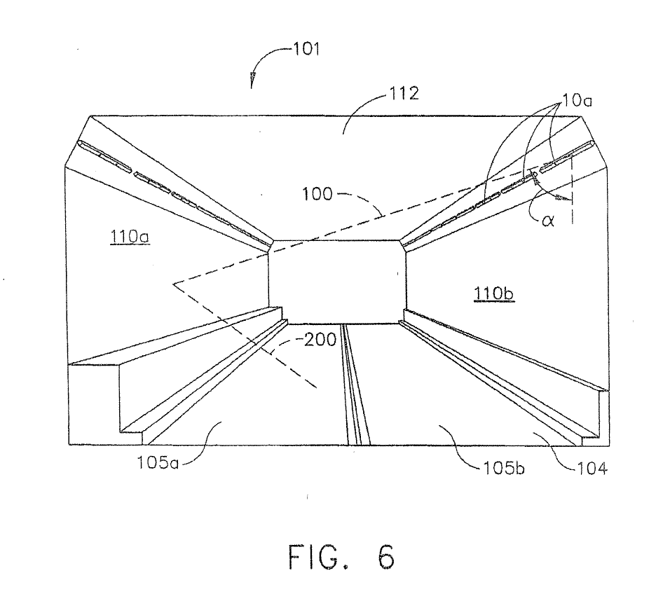

In another embodiment, not specifically shown, the linear luminaries 1 can be affixed to the tunnel ceiling 112 in a linear array, and positioned to direct the emitted light along the cen[0062] In yet another embodiment shown in FIG. 6, the linear luminaries 1 can be affixed to the tunnel wall 110b in at least one linear array, and positioned to direct the emitted light along the centerline 100 of the LEDs at the opposite tunnel wall. While visibility of the roadway itself is an important criterion, in certain traffic tunnels, such as very long tunnels where the vehicle operator may not be able to see the exit from the tunnel for some time, visibility of the tunnel walls can be important. In such circumstances, it is typical to have a tunnel wall surface made of a material having high reflectance, such that a portion of the light emitted from the LEDs along LED centerline 100 that does strike the reflective tunnel wall surface will in turn be reflected along reflecting line 200 down to the traffic surface, providing a synergistic lighting of both the traffic surface and the tunnel walls. The centerline 100 of the LEDs, and more particularity the light emitted therefrom, is preferably disposed at an angle of about 50° to about 80°, and more preferably from about 60°-70°, from vertical.

In yet another embodiment shown in FIG. 6, the linear luminaries 1 can be affixed to the tunnel wall 110b in at least one linear array, and positioned to direct the emitted light along the centerline 100 of the LEDs at the opposite tunnel wall. While visibility of the roadway itself is an important criterion, in certain traffic tunnels, such as very long tunnels where the vehicle operator may not be able to see the exit from the tunnel for some time, visibility of the tunnel walls can be important. In such circumstances, it is typical to have a tunnel wall surface made of a material having high reflectance, such that a portion of the light emitted from the LEDs along LED centerline 100 that does strike the reflective tunnel wall surface will in turn be reflected along reflecting line 200 down to the traffic surface, providing a synergistic lighting of both the traffic surface and the tunnel walls. The centerline 100 of the LEDs, and more particularity the light emitted therefrom, is preferably disposed at an angle of about 50° to about 80°, and more preferably from about 60°-70°, from vertical.

In a similar embodiment, the linear luminaries 1 are positioned along the tunnel ceiling 112, and positioned to direct the emitted light at either or both of the adjacent and far tunnel wall 110, and indirectly by reflection to the traffic surface 104. Such embodiments are particularly effective when the tunnel walls are made of reflective construction material, such as ceramic tile. The reflectance of a typical ceramic tile is more typically about 40-60%. An asphalt roadway, by comparison, has reflectance of about 10% or less. Consequently, a lighting system that provides a majority of the emitted light to the reflective tunnel walls, provides sufficient amounts of lighting to the roadway (through some direct lighting and from reflected light from the tunnel wall reflective surface) to effectively light the tunnel. The centerline 100 of the emitted light emitted from the ceiling is can be disposed toward the tunnel wall at an angle of about 15° to about 45° from vertical.terline 100 of the LEDs, at either or any of the traffic lanes 105.

Typical standards for the amount of lighting for tunnel walls and roadways are disclosed in Recommended Practices Standard 22 (RP-22), published by the Illuminating Engineering Society of North America (IESNA), the disclosure of which is incorporated herein by reference.

In alternative embodiments, additional linear arrays of the LEDS lights along the length of the traffic surface can be placed in locations offset from the first linear array, on other portions of the tunnel wall or the ceiling, as the design and requirements of the tunnel may indicate.

### Linear Lighting System

In one embodiment, a linear luminaire lighting system is shown in FIGS. 7-10. The linear luminaire lighting system can be anew installation into a newly constructed tunnel, or can be retrofitted into an existing tunnel in place of the existing conventional lighting system. The linear luminaire lighting is installed into a roadway tunnel similar to the one shown in FIG. 3. The existing power nodes and existing lighting fixtures (e.g., HID light fixtures) are removed from the tunnel wall 110, and a power and control interface module 80 is affixed (with bolts 84A) flush with the tunnel wall 110 to cover each fixture opening. The power for the linear lighting system is provided by the existing 120-277 volts AC used for the HID lamps at each fixture opening. A detachable power cover plate 85 covers a power transformer (not shown) that converts the pre-existing 120-277 volts AC power to a highly constant 24 volt DC, which feeds through a power supply cable 95 near the bottom of plate 81 behind splice cover plate 88, to power the plurality of the LEDs of the linear luminaires. A suitable LED power source for delivering highly consistent, low voltage DC power is an HV9910 LED driver, available from Supertex, Inc. of Sunnyvale, Calif.

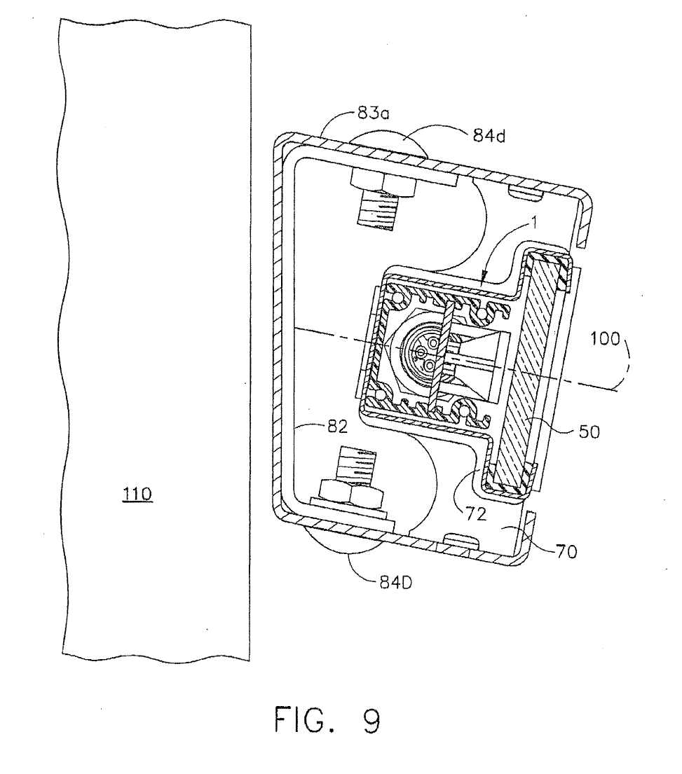

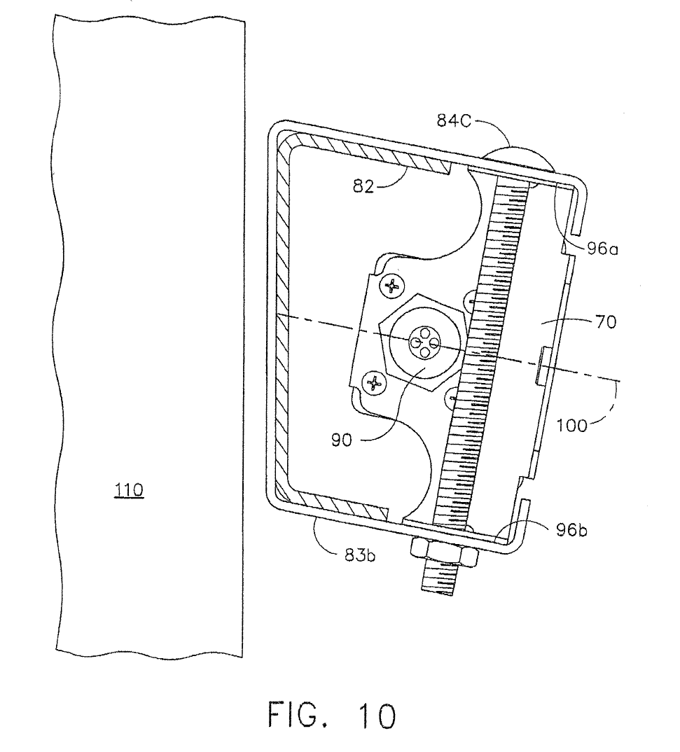

A pair of luminaire support racks 86 and 83a are affixed at near ends to the module cover plate 81 with bolts 84B. The opposite end of first support track 83a is coupled with a splice channel 82 to a second support track 83b, secured by splice-track bolts 84D. Though not shown, the opposite end of second support track 83b is similarly coupled with another splice channel to a third support track 83c, to create a three-track unit. The splice channel 82 spans across a short space between the adjacent support tracks 83a and 83b, and overlaps the ends of the support tracks sufficiently for securement thereto. The opposite end of third support track 83 c is secured to the next power and control interface module down the length of the tunnel, in a fashion identical to the attachment of track 86 to module plate 81 in FIG. 7. Similar three-track units are secured along the entire length of the tunnel between adjacent power and control interface modules. The use of splice channels 82 between adjacent lengths of track 83/86 allows the installation and securing of the luminaire support tracks between modules without the need to dredge through the tunnel wall in between modules to secure the tracks. Note the spacing between the tunnel wall 110 and the track 83 in FIGS. 9 and 10. This provides a significant savings in time and expense when retrofitting a linear luminaire system within an existing tunnel. In the illustrated embodiment, the length of each support track is about 6 feet (1.8 m), and the spacing between adjacent power and control interface modules is about 20 feet (6.1 m).

Within each length of track 83a, 83b and 83c is inserted a linear luminaire 1 according to the present invention. As can be seen in FIG. 7, each linear luminaire 1 is inserted in through the front opening in the track 86/83 that is defined between distal ends 87a and 87b. Each inserted linear luminaire 1 is then secured against the front opening of the track 83/86 and flush with the curved corners of distal ends 87a and 87b, as shown in FIGS. 9 and 10, by passing bolts 84C through aligned holes formed in the ends of each track 83/86 and in the securing flanges 96a,b of end plates 70, shown in FIG. 1, thereby securing the linear luminaire 1 from movement in all directions and from rotation within the track. This embodiment also rigidly fixes the centerline of the LEDs 100 at an angle relative to the tunnel wall 110.

As shown in FIG. 7, after each linear luminaire 1 is installed and secured, a bridging cable 94 is connected between the confronting electrical connectors 90 of adjacent linear luminaires 1. In the illustrated embodiment, power (about 100 W, delivered at 24 volts) is distributed only in one direction along the tunnel out of each power and control interface module, to only one three-track luminaire grouping. Thus, referring to FIG. 7, the 24 volt DC power from power and control interface module 80 is fed into and through the linear luminaires secured within support tracks 83a, 83b and 83c (not shown), while power for the luminaire that is installed into track 86 is supplied from the next module down (toward the left) the tunnel.

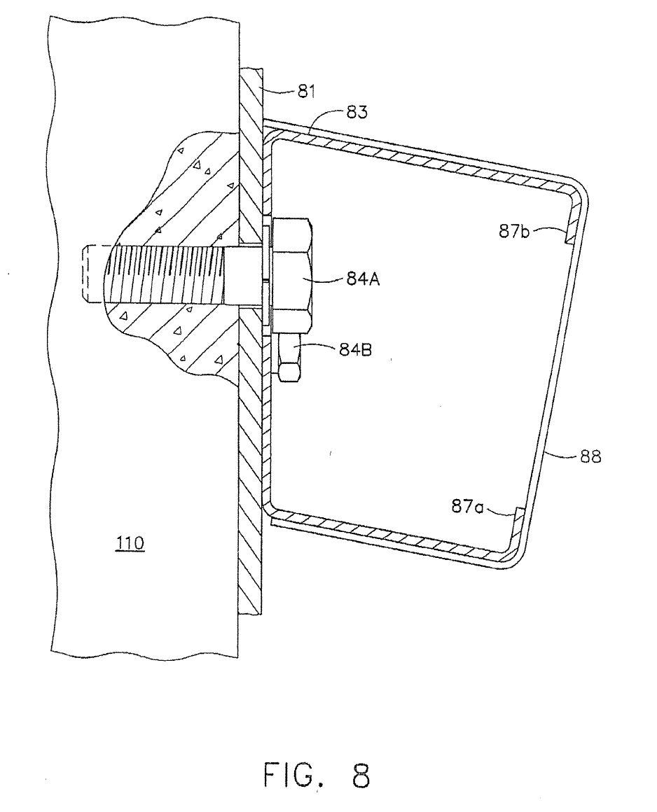

It should be understood from sectional view FIG. 8 that the splice cover plate 88 is attached over the ends of adjacent tracks 86 and 83a after the linear luminaires 1 have been installed, and can be secured to the ends of the support tracks with screws or bolts (not shown). Similar splice cover plates are installed over the confronting ends of support tracks to cover the splice channels and bridging cables.

The linear lighting system shown in FIGS. 7-10 rigidly fixes the centerline of the LEDs 100 at an angle relative to the tunnel wall 110. Different angles can be achieved by configuring the support tracks 83/86 to hold and secure the linear luminaires in a different angle against the distal ends 87a and 87b of the track 83/86. An alternative embodiment of the luminaire support system can provide a means for pivoting the linear luminaire within the track support system in order to adjust the angle of the LED centerline relative to the tunnel wall for achieving optimum or different lighting effects.

By comparison, the conventional incandescent, fluorescent, and HDD lamps of conventional tunnels provide areas of more intense illumination along the tunnel, on the roadway, tunnel walls, and ceiling, because of the wider illumination patterns of these lights that are typically spaced several meters apart. The large point light sources of a conventional tunnel also complicate the directing of the emitted light onto the traffic surface in a uniform manner, which therefore requires over-lighting some areas in order to obtain the minimum amount of lighting in all areas, and thus wasting both emitted light and electricity. By comparison, the linear luminaires of the present invention place the emitted light more precisely and uniformly upon the traffic surface, thus reducing the electrical power required to adequately illuminate the tunnel.

The present invention provides the use of light emitting diodes (LEDs) that are more energy efficient, up to 30% (and higher), and more generally up to 20%, more energy efficient with the same illumination than conventional lamps. The LED lights provide long light life of up to 50.000 hours, and in some embodiments, up to 100,000 hours and more, which far exceeds the average life of lamps of conventional light systems that use incandescent and HID (high intensity discharge) lamps. LEDs also have better sustained light performance than conventional incandescent and HID lamps, which can loose lumen output over time. LED light systems also operate with a lower voltage (for example, 15 volts or 24 volts DC, compared to conventional 120, 240 and 480 voltage AC systems), which improves operational and maintenance safety, and enables battery back-up. LEDs also have a shorter height compared to conventional lamps, enabling a lower luminaire profile. LEDs lighting also provides “instant on” light, as opposed to conventional HID lights that generally require an extended warm-up time (up to 10 minutes, or more).

LED lumen output is also more easily controlled based on the control of power into the LED lamp, as compared to the conventional lamps. The lumen output of one or a matrix of LEDs can also be varied linearly by adjusting the amps passed through the LED, and thus providing precise control of the amount of lumens required, and enabling variation of the total lumens of light emitted based on environmental conditions, such as daytime versus nighttime lighting. By comparison, conventional lamps typically come in unit sizes of 100 W, 150 W, 200 W, etc, such that the light emittance can not be readily controlled. The power controller means can be configured to dim some or all of the linear array light fixtures at a time, or for a period of time. The controller can also be configured to automatically engage dimming of the LEDs, based on a time cycle, outdoor brightness, or for other conditions.

The linear light source of the present invention also provides the advantage of reducing or eliminating the stroboscopic effect that can occur in tunnel and bridge lighting systems with conventional incandescent and HID lights.

The linear luminaire, and the linear lighting system, disclosed herein are particularly well suited for wet and dusty environments because their designs have no unsealed openings into electric contacts into which water and dust can gain egress. The design of the linear lighting system also has minimal external fasteners such as screws or bolts, on the front, top, or front surfaces of the system, which can accumulate dirt and which can snag the brushes of an industrial tunnel cleaning device which uses an aqueous washing solution sprayed at high pressures and the rotating bushes to dislodge dirt form the tunnel walls and light fixtures. The present design has a low profile, and few exposed corners and recesses, allowing such equipment to effectively clean both the tunnel wall and the linear luminaire lighting system with minimum breakage and damage to the equipment and to the luminaires. Improved tunnel and luminaire cleaning in turn provides better and brighter lighting within the tunnel.

Because of the long life and maintenance free operation of LEDs, the linear luminaires and linear lighting systems employing them are advantageously designed and constructed for equally long operating life, without requiring maintenance or replacement throughout the lifetime of the LEDs, typically 10 years, and often more. Environmental and operating factors that can affect the maintenance, repair, and replacement of the linear luminaires and linear lighting systems include the temperature with the tunnel and within the linear luminaire, maintenance within the tunnel that subjects the linear luminaires to dust, water and corrosion, and the exposure of the linear luminaires and the lighting system to physical damage from maintenance and cleaning equipment and vehicle traffic. Consequently, the metal parts of the linear luminaire and linear lighting system are preferably constructed of stainless steel or other non-corrosive, durable metal or plastic.

The present invention also provides the use of a lighting system for a tunnel, rail station, hallway, corridor and bridgeway that directs or focuses the emitted light onto the

traffic surface for more efficient use of the available lumens, and that provides a more uniform distribution of the light onto the traffic surface.

Optional conventional reflector panels can be associated with the linear array light fixture 10 or with the linear luminaire 1 to reflect light emitted from the plurality of LEDs disposed along the length of the fixture or luminaire, toward a direction along the centerline 100 of the LEDs.

While specific embodiments of the apparatus and method of the present invention have been described, it will be apparent to those skilled in the metalworking arts that various modifications thereto can be made without departing from the spirit and scope of the present invention as defined in the appended claims.

1-4. (canceled)

5. A method for lighting a tunnel having a traffic surface and at least one tunnel wall, wherein at least a portion of the tunnel wall has an exterior surface having a reflectance of at least 30%, comprising the steps of:
a. positioning a plurality of luminaries comprising a plurality of light sources arranged in a linear array, horizontally within the tunnel wall; and
b. directing and controlling the emitted light from the plurality of light sources wherein at least 50% of the emitted light is directed at the exterior surface of the tunnel wall and reflects from the tunnel wall to the traffic surface.

6. The method according to claim 5 wherein the exterior surface is selected from the group consisting of ceramic tile, concrete, painted concrete, and other painted surfaces.

7-13. (canceled)

14. A method for lighting a tunnel defining a length and comprising a traffic surface having a first side and a second side, and at least one tunnel wall, the method comprising:
a. positioning a plurality of linear luminaires comprising a plurality of light sources arranged in a substantially linear array horizontally along at least one of the tunnel walls, and
b. directing and controlling the emitted light from the light sources wherein at least 50% of the emitted light from the LEDs is directed at the traffic surface perpendicular to the traffic surface in the direction along the length of the tunnel, and at an angle to the traffic surface in a direction perpendicular to the length of the tunnel.

15. The method of claim 5 wherein one or more of the light sources is a light emitting diode.

16. The method of claim 14 wherein one or more of the light sources is a light emitting diode.

17. A lighting fixture comprising for lighting a traffic tunnel comprising a tunnel wall, the fixture comprising:
a. at least one light source within a frame, the light source defining a centerline; and
b. the fixture configured such that the light source centerline defines an angle of from about 15° to about 45° from vertical.

18. The fixture of claim 17 wherein one or more light source is a light emitting diode.

19. The fixture of claim 17 wherein the light source centerline defines an angle of about 20° from vertical.

20. The fixture of claim 17 wherein the fixture is mounted to one of the one or more tunnel walls and the light source centerline is perpendicular to the portion of the tunnel wall on which the fixture is mounted.

21. A lighting fixture comprising for lighting a traffic tunnel comprising one or more tunnel walls, the fixture comprising:
a. at least one light source within a frame, the light source defining a centerline;
b. the fixture configured such that the light source centerline defines an angle of about from about 50° to about 80° from vertical; and
c. the light source centerline is directed toward one of the one or more tunnel walls.

22. The fixture of claim 21 wherein one or more light source is a light emitting diode.

23. The fixture of claim 21 wherein the light source centerline defines an angle of about from about 60° to about 70° from vertical.

24. The fixture of claim 21 wherein the fixture is mounted to one of the one or more tunnel walls and the light source centerline is perpendicular to the portion of the tunnel wall on which the fixture is mounted.
